(19) United States
(12) Patent Application Publication
(10) Pub. No.: US 2026/0074314 A1
(43) Pub. Date: Mar. 12, 2026

(54) APPARATUS AND METHOD FOR DISPOSING OF BATTERY CELLS

(71) Applicant: SK ON CO., LTD., Seoul (KR)

(72) Inventor: Hyeong Yun LEE, Daejeon (KR)

(21) Appl. No.: 19/319,670

(22) Filed: Sep. 4, 2025

(30) Foreign Application Priority Data
Sep. 11, 2024 (KR) 10-2024-0124214

(51) Int. Cl. H01M 10/54; B09B 3/32; B09B 3/35; B09B 101/16

(52) U.S. Cl. CPC H01M 10/54; B09B 3/32; B09B 3/35; B09B 2101/16

(57) ABSTRACT

Proposed is an apparatus for disposing of battery cells, the apparatus comprising, a conveying device conveying a worktable with a battery cell placed thereon in one direction, a guiding device guiding a position where the battery cell is to be placed on the worktable and sensing whether the battery cell is placed on the worktable, a sensing device sensing a presence or absence of a folding portion and a length of a tab of the battery cell, an aligning device aligning the battery cell in a first direction based on the presence or absence of the folding portion and in a second direction based on the length of the tab, a damaging device damaging a part of a pouch film so that an electrode assembly is exposed, and an unloading device making contact with a lower surface of the damaged battery cell and lifting the battery cell from the worktable.

### CROSS REFERENCE TO RELATED APPLICATION

The present application claims priority to Korean Patent Application No. 10-2024-0124214, filed Sep. 11, 2024, the entire contents of which is incorporated herein for all purposes by this reference.

### TECHNICAL FIELD

The present disclosure relates to an apparatus and method for disposing of battery cells.

### BACKGROUND

Battery cells are used in eco-friendly vehicles such as electric vehicles (EVs) and hydrogen fuel cell vehicles (FCEVs). During the battery manufacturing process, defective battery cells can be produced. Battery cells at the end of their lifespan or that are defective need to be disposed of to recover valuable materials or processed in an environmentally responsible way. To this end, it is generally necessary to discharge the battery cell to remove stored electricity, followed by dismantling the cell to physically separate a positive electrode, a separator, and a negative electrode. Since the battery cell stores electrical energy and contains highly reactive metals such as lithium or nickel, it poses significant safety risks to workers who perform a cutting process required for discharging the cell prior to dismantling.

The foregoing is intended merely to aid in the understanding of the background of the present disclosure, and is not intended to mean that the present disclosure falls within the purview of the related art that is already known to those skilled in the art.

### SUMMARY

The present disclosure is to provide an apparatus and method for disposing of battery cells safely.

According to an aspect of the present disclosure, there is provided an apparatus for disposing of battery cells, the apparatus comprising: a conveying device configured to convey a worktable with a battery cell placed thereon in one direction; a guiding device configured to guide a position where the battery cell is to be placed on the worktable and sense whether the battery cell is placed on the worktable; a sensing device configured to sense a presence or absence of a folding portion and a length of a tab of the battery cell; an aligning device configured to align the battery cell in a first direction based on the presence or absence of the folding portion and align the battery cell in a second direction based on the length of the tab; a damaging device configured to damage a part of a pouch film so that an electrode assembly inside the battery cell is exposed; and an unloading device configured to make contact with a lower surface of the damaged battery cell and lift the battery cell from the worktable.

According to an embodiment, the damaging device may comprise either or both of: a cutting device configured to cut a region between a cup portion and a tab weld of the battery cell to open a side surface of the battery cell; and an incising device configured to incise the pouch film of the cup portion on an upper surface of the battery cell.

According to an embodiment, the guiding device may comprise: a guide jig configured to guide the battery cell to be placed in a predetermined position on the worktable; and a position sensor configured to measure whether the battery cell is placed on the worktable.

According to an embodiment, the guide jig may comprise: a first type guide jig configured to guide the position where the battery cell is to be placed on the worktable when the battery cell has a structure in which a positive electrode tab and a negative electrode tab face each other; and a second type guide jig configured to guide the position where the battery cell is to be placed on the worktable when the battery cell has a structure in which the positive electrode tab and the negative electrode tab are formed at one side of the battery cell.

According to an embodiment, the sensing device may comprise: a board having at least one slit formed therein; and a plurality of sensors fixed at predetermined positions in the slits of the board.

According to an embodiment, the sensors may comprise: a first sensor configured to measure the presence of absence of the folding portion of the battery cell; and a second sensor configured to measure the length of the tab of the battery cell.

According to an embodiment, the cutting device may comprise: a fixing part configured to pressurize and fix opposite sides of the cup portion of the battery cell; and a cutting part configured to cut a region between the tab weld and a positive electrode tab or an electrode tab of the battery cell.

According to an embodiment, the cutting part may comprise: a lower blade disposed on the lower surface of the battery cell; an upper blade disposed on the upper surface of the battery cell; and a blade driving portion configured to cut the battery cell by moving the upper blade toward the lower blade.

According to an embodiment, the incising device may comprise: a knife configured to incise the pouch film of the battery cell; a pressing part located in a front area in a direction in which the knife moves and configured to move while pressing the pouch film; and a moving part configured to move the knife and the pressing part in a direction in which incising proceeds.

According to an embodiment, the pressing part may comprise: a roller configured to rotate in contact with the pouch film of the battery cell; and an elastic portion configured to press the roller against the battery cell with a predetermined pressure.

According to an embodiment, the unloading device may comprise: a plurality of forks configured to make contact with the lower surface of the battery cell; a fork driving part to which the plurality of forks are connected and configured to move the plurality of forks to narrow or widen the forks; and a fork moving part connected to the fork driving part and configured to move the plurality of forks.

According to an embodiment, the worktable may have a plurality of fork grooves formed at positions where the plurality of forks make contact with the lower surface of the battery cell so that when the fork driving part narrows the forks, the forks are inserted into the fork grooves of the worktable.

According to another aspect of the present disclosure, there is provided a method of disposing of battery cells, the method comprising: placing a battery cell onto a worktable of a conveying device using a guiding device; sensing, by the guiding device, a position where the battery cell is placed; sensing, by a sensing device, a presence or absence of a folding portion and a length of a tab of the battery cell conveyed by the conveying device; aligning, by an aligning device, the battery cell conveyed by the conveying device in a first direction based on the presence or absence of the folding portion and aligning the battery cell in a second direction based on the length of the tab; damaging a part of a pouch film of the battery cell conveyed by the conveying device so that an electrode assembly inside the battery cell is exposed; and making contact with a lower surface of the damaged battery cell conveyed by the conveying device and lifting and unloading the battery cell from the conveying device.

According to an embodiment, the damaging of the part of the pouch film may comprise either or both of: cutting, by a cutting device, a region between a cup portion and a tab weld of the battery cell conveyed by the conveying device; and incising, by an incising device, the pouch film of the cup portion on an upper surface of the battery cell conveyed by the conveying device.

According to an embodiment, the incising of the pouch film may comprise: moving, by a moving part of the incising device, a knife and a pressing part to a predetermined position of the battery cell; pressurizing, by the moving part of the incising device, the knife so that the knife pierces a cup portion of the battery cell to a predetermined depth; and moving, by the moving part of the incising device, the pressing part and the knife in a predetermined direction so that the knife incises the pouch film while the pressing part presses the pouch film.

According to an embodiment, the pressing part may comprise: a roller rotating in contact with the pouch film of the battery cell; and an elastic portion pressing the roller against the battery cell with a predetermined pressure, wherein the elastic portion may press the roller against the pouch film of the cup portion of the battery cell, and the roller may press the pouch film sequentially in a direction in which the moving part moves while rotating.

According to an embodiment, the unloading of the battery cell may comprise: widening, by a fork driving part of the unloading device, a plurality of forks so that a distance between the forks exceeds a size of the battery cell; moving, by a fork moving part of the unloading device, the forks to below the lower surface of the battery cell; narrowing, by the fork driving part of the unloading device, the forks so that the distance between the forks is less than the size of the battery cell; and lifting, by the fork moving part of the unloading device, the forks so that the forks make contact with the lower surface of the battery cell, and unloading the battery cell from the conveying device, wherein the worktable may have a plurality of fork grooves formed at positions where the plurality of forks make contact with the lower surface of the battery cell so that when the fork driving part narrows the forks, the forks are inserted into the fork grooves of the worktable.

The features and advantages of the present disclosure will be more clearly understood from the following detailed description when taken in conjunction with the accompanying drawings.

The terms and words used in the specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe the best method he or she knows for carrying out the present disclosure.

By using the apparatus and method for disposing of battery cells according to the present disclosure, it is possible to safely dismantle and dispose of battery cells.

By using the apparatus and method for disposing of battery cells according to the present disclosure, it is possible to stabilize the quality of incision or cutting of battery cells.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating an apparatus for disposing of battery cells according to an embodiment;

FIG. 2 is a view illustrating a method for disposing of battery cells according to an embodiment;

FIG. 3 is a view illustrating the arrangement of a guide jig of a guiding device and a conveying device according to an embodiment;

FIG. 4 is a view illustrating a position where a battery cell is to be placed according to an embodiment;

FIG. 5 is a view illustrating a sensing device for sensing a folding portion and a tab of a battery cell according to an embodiment;

FIG. 6 is a view illustrating a step of aligning battery cells by an aligning device according to an embodiment;

FIG. 7 is a view illustrating a position where a cutting device cuts a battery cell according to an embodiment;

FIG. 8 is a view illustrating a cutting device for cutting a battery cell according to an embodiment;

FIG. 9 is a view illustrating a position where a battery cell is incised and an incising device according to an embodiment;

FIG. 10 is a view illustrating a step of incising a battery cell according to an embodiment;

FIG. 11 is a view illustrating an unloading device for unloading a battery cell according to an embodiment;

FIG. 12 is a view illustrating a worktable with a fork groove formed therein according to an embodiment;

FIG. 13 is a view illustrating an unloading device with no worktable according to an embodiment; and

FIG. 14 is a view illustrating a step of unloading a battery cell by an unloading device according to an embodiment.

### DETAILED DESCRIPTION

The above and other objectives, features, and advantages of the disclosure will be more clearly understood from the following detailed description taken in conjunction with the accompanying drawings, but the disclosure is not necessarily limited thereto. Further, when it is determined that the detailed description of the known art related to the disclosure might obscure the gist of the disclosure, the detailed description thereof will be omitted.

As for reference numerals associated with parts in the drawings, the same or similar reference numerals will refer to the same or similar elements throughout different drawings.

The terminology used to describe an embodiment of the present disclosure is not intended to limit the present disclosure. As used herein, the singular forms are intended to comprise the plural forms as well, unless the context clearly indicates otherwise.

Note that the drawings may be schematic or exaggerated to illustrate implementations.

The terms “have”, “may have”, “comprise”, and “may comprise” as used herein indicate the presence of corresponding features (for example, elements such as numerical values, functions, operations, or parts), and do not preclude the presence of additional features.

Although the terms “one”, “other”, “another”, “first”, “second”, etc. may be used only to distinguish one element from another element, these elements should not be limited by these terms.

The terms indicating directions such as up, down, left, right, X-axis, Y-axis, Z-axis, etc. are merely for convenience of description, and it should be understood that these terms may vary depending on the position of an observer or the position of an object.

The embodiment described in the specification and accompanying drawings should not be construed as being limited to only the embodiments set forth herein. The disclosure should be construed as covering modifications, equivalents, and/or alternatives of the disclosure.

Hereinbelow, exemplary embodiments of the disclosure will be described in detail with reference to accompanying drawings.

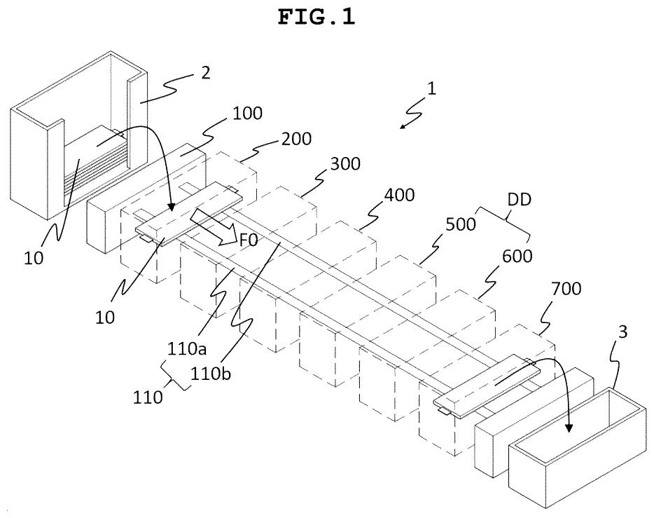

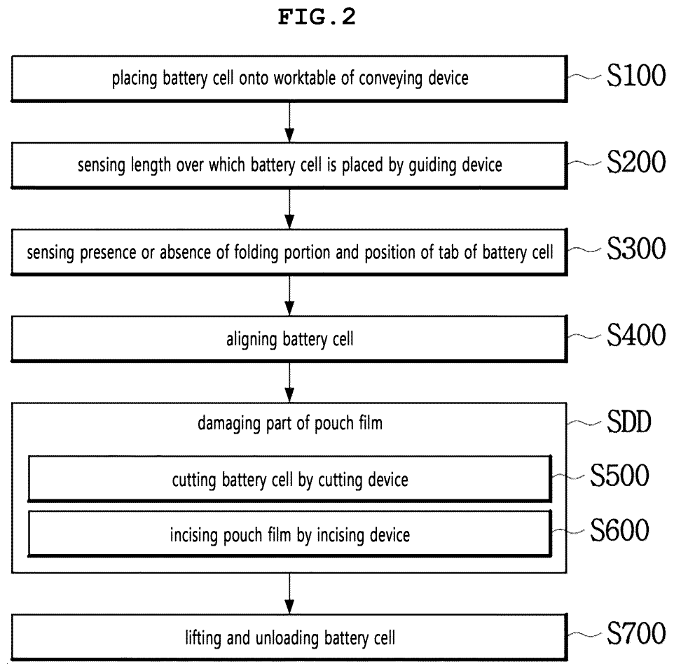

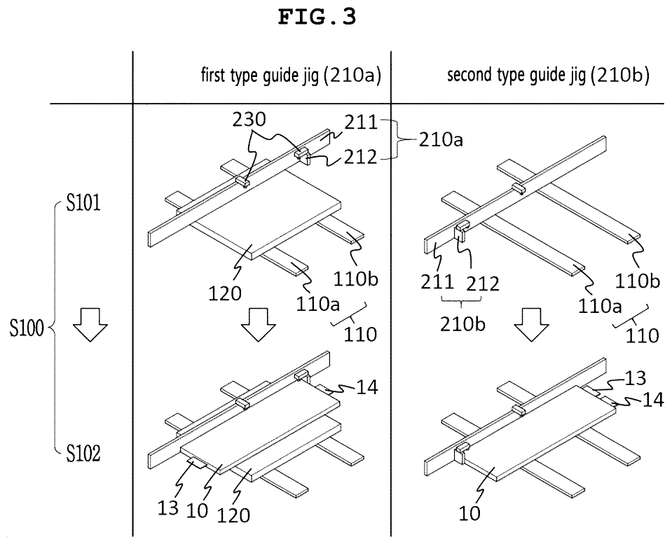

FIG. 1 is a view illustrating an apparatus 1 for disposing of battery cells according to an embodiment. FIG. 2 is a view illustrating a method for disposing of battery cells according to an embodiment. FIGS. 3 to 14 are views illustrating a device comprising the apparatus 1 for disposing of battery cells, and thus are referred together.

The apparatus 1 for disposing of battery cells may comprise: a conveying device 100 that conveys a worktable 120 with a battery cell 10 placed thereon in one direction; a guiding device 200 that guides a position where the battery cell 10 is to be placed on the worktable 120 and senses whether the battery cell 10 is placed on the worktable 120; a sensing device 300 that senses the presence or absence of a folding portion 16 and the length of a tab of the battery cell 10; an aligning device 400 that aligns the battery cell 10 in a first direction F1 based on the presence or absence of the folding portion 16 and aligns the battery cell 10 in a second direction F2 based on the length of the tab; a damaging device DD that damages a part of a pouch film 12 so as to expose an electrode assembly 11 inside the battery cell 10; and an unloading device 700 that makes contact with a lower surface of the damaged battery cell 10 and lifts the battery cell 10 from the worktable 120.

The method for disposing of battery cells may comprise: placing a battery cell 10 onto a worktable 120 of a conveying device 100 using a guiding device 200 (S100); sensing, by the guiding device 200, a position where the battery cell 10 is placed (S200); sensing, by a sensing device 300, the presence or absence of a folding portion 16 and the length of a tab of the battery cell 10 conveyed by the conveying device 100 (S300); aligning, by an aligning device 400, the battery cell 10 conveyed by the conveying device 100 in a first direction F1 based on the presence or absence of the folding portion 16 and aligning the battery cell 10 in a second direction F2 based on the length of the tab (S400); damaging a part of a pouch film 12 of the battery cell 10 conveyed by the conveying device 100 so that an electrode assembly 11 inside the battery cell 10 is exposed (SDD); and making contact with a lower surface of the damaged battery cell 10 conveyed by the conveying device 100 and lifting and unloading the battery cell 10 from the conveying device 100 (S700).

The apparatus 1 for disposing of battery cells according to the embodiment may safely damage a part of the pouch film 12 of the battery cell 10. The battery cell 10 in which the pouch film 12 is damaged by the apparatus 1 and thereby the electrode assembly 11 is exposed to the outside may be immersed in a discharge tank 3 for discharging. The damaged battery cell 10 may be loaded into a buffer or the like for storing damaged battery cells 10 rather than being placed into the discharge tank 3. The apparatus 1 for disposing of battery cells may safely damage the battery cell 10 in which electrical energy is stored, thereby ensuring the safety of workers.

The conveying device 100 is a device that moves the battery cell 10 to a subsequent step. The conveying device 100 may comprise devices such as a conveyor belt 110 and a linear motion system (LMS). The conveying device 100 may comprise the worktable 120. The worktable 120 may allow the battery cell 10 to be placed thereon. The worktable 120 may be conveyed by the conveying device 100. The conveying device 100 may move the worktable 120 by one pitch at a time depending on processes. Moving by one pitch at a time may mean that the worktable 120 moves to a subsequent process, such as moving from the guiding device 200 to the sensing device 300 or from the damaging device DD to the unloading device 700. In this case, moving two pitches may mean skipping one step. The worktable 120 may be a carrier of a linear motion system, a worktable 120 coupled to the carrier, a part of the conveyor belt 110, or a worktable 120 coupled to the conveyor belt 110. The conveying device 100 may sequentially convey the battery cell 10 on the worktable 120 from the guiding device 200 to the sensing device 300, the aligning device 400, the damaging device DD (a cutting device 500, an incising device 600), and the unloading device 700.

The guiding device 200 is used in the process of placing the battery cell 10 onto the conveying device 100. The guiding device 200 guides the battery cell 10 to be placed in a predetermined position on the worktable 120. Battery cells 10 that remain unloaded onto the conveying device 100 may stand by in a state of being stored in a magazine 2. A worker may load each of the battery cells 10 stored in the magazine 2 into a predetermined position on the worktable 120 using the guiding device 200. Alternatively, a robot for conveying the battery cells 10 may load each of the battery cells 10 stored in the magazine 2 into a predetermined position on the worktable 120 using the guiding device 200. Here, loading means conveying the battery cell 10 to the worktable 120. When the battery cell 10 is placed in a predetermined position on the worktable 120, the conveying device 100 may move the worktable 120 by one pitch to a subsequent step.

The sensing device 300 may measure the presence or absence of the folding portion 16 and the length of the tab of the battery cell 10. The folding portion 16 refers to a part where a sealing portion 15 of the battery cell 10 is folded or rolled. The distance by which the battery cell 10 is moved by the aligning device 400 may vary depending on whether the folding portion 16 is present. The term “tab” collectively refers to a positive electrode tab 13 and a negative electrode tab 14. The length of the tab is a measurement of how long the tab is. The length of the tab may be determined by measuring the position of an end of the tab. Since there are various specifications for the battery cell 10, the length of the tab may be measured and the battery cell 10 may be moved and aligned by the aligning device 400 based on the measured length of the tab.

The aligning device 400 may align the battery cell 10 to a predetermined position. The aligning device 400 may precisely move the battery cell 10 using a servo motor. Depending on the presence or absence of the folding portion 16, the battery cell 10 may be aligned in the first direction F1. When the battery cell 10 is loaded onto the worktable 120 in a direction in which the tab of the battery cell 10 is orthogonal to a convey direction F0 of the conveying device 100, the first direction F1 corresponds to the convey direction P0 of the conveying device 100. The aligning device 400 may align the battery cell 10 in the second direction F2 depending on the position of the tab. When the battery cell 10 is loaded onto the worktable 120 in a direction in which the tab of the battery cell 10 is orthogonal to the convey direction P0 of the conveying device 100, the second direction F2 is orthogonal to the convey direction P0 of the conveying device 100.

The damaging device DD is a device that damages a part of the pouch film 12 of the battery cell 10. The damaging device DD may comprise either or both of the cutting device 500 that cuts a region between a cup portion 17 and a tab weld TW of the battery cell 10 to open a side surface of the battery cell 10, and the incising device 600 that incises the pouch film 12 of the cup portion 17 on an upper surface of the battery cell 10. The apparatus 1 for disposing of battery cells according to the embodiment may comprise only the cutting device 500, only the incising device 600, or both the cutting device 500 and the incising device 600. The conveying device 100 may convey the battery cell 10 in which a part of the electrode assembly 11 is exposed to the outside by the damaging device DD to the unloading device 700.

In the damage device DD, the cutting device 500 is a device that cuts a portion where the tab of the battery cell 10 is connected. When one side of the battery cell 10 is cut, the electrode assembly 11 may be exposed to the outside through the cut portion. The cutting device 500 cuts the portion where the tab of the battery cell 10 is connected, thereby damaging the side surface of the battery cell 10.

In the damaging device DD, the incising device 600 is a device that incises the pouch film 12 of the cup portion 17 in which the electrode assembly 11 of the battery cell 10 is accommodated. The incising device 600 incises the upper surface of the battery cell 10. The incising device 600 is a device that damages the upper surface of the battery cell 10.

The unloading device 700 is a device that unloads the damaged battery cell 10 from the worktable 120. The unloading device 700 may convey the battery cell 10 to the discharge tank 3. Alternatively, the unloading device 700 may convey the damaged battery cell 10 to a predetermined location. The unloading device 700 may convey the battery cell 10 by lifting a lower surface of the battery cell 10 without making contact with the damaged portion of the battery cell 10. Since the damaging device DD cuts the side surface of the battery cell 10 where the tab is located or cuts the upper surface of the cup portion 17, the lower surface of the battery cell 10 remains without being damaged. The unloading device 700 may lift the lower surface of the battery cell 10 while avoiding contact with the cut or incised portion of the battery cell 10.

This process ensures that a part of the pouch film 12 is safely damaged in order to immerse the battery cell 10 in the tank 3 for discharging.

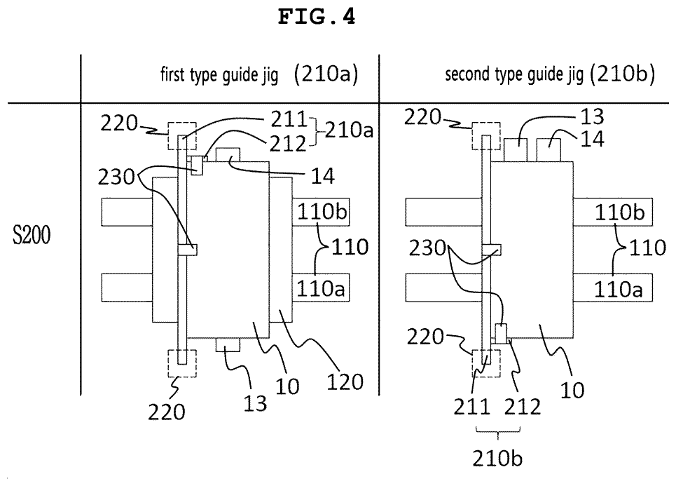

FIG. 3 is a view illustrating the arrangement of a guide jig 210 of a guiding device 200 and a conveying device according to an embodiment. FIG. 4 is a view illustrating a position where a battery cell 10 is to be placed according to an embodiment. FIGS. 1 to 4 are referred together. In FIGS. 3 and 4, the general configuration of the conveying device 100 and the guiding device 200 is omitted.

The conveying device 100 may be a conveyor belt 110. The conveyor belt 110 may comprise a first belt 110a and a second belt 110b. The conveyor belt 110 may be a continuous single belt. The guiding device 200 is installed at a position where the battery cell 10 is loaded. The guiding device 200 may be fixed to a predetermined position with respect to the conveying device 100. The guiding device 200 may be installed apart from the conveying device 100 so as not to interfere with the path along which the conveyor belt 110 and a worktable 120 move.

The worktable 120 may be coupled onto the conveyor belt 110. The left drawing of FIG. 3 for a first type guide jig 210a illustrates a conveying device 100 with a worktable 120. The right drawing of FIG. 3 for a second type guide jig 210b illustrates a conveying device 100 with no worktable 120. At this time, the conveyor belt 110 itself may be referred to as a worktable 120.

The guiding device 200 may comprise the guide jig 210 that guides the battery cell 10 to be placed in a predetermined position on the worktable 120, and a position sensor 230 that measures whether the battery cell 10 is placed on the worktable 120. The guiding device 200 may comprise a pair of jig supports 220 (see FIG. 4) that support the guide jig 210 so that the guide jig 210 is fixed in a correct position. The guide jig 210 may be detachably coupled to the jig supports 220. The jig supports 220 are provided as a part of the guiding device 200, and description of the remaining parts of the guiding device 200 is omitted.

The guide jig 210 may comprise the first type guide jig 210a that guides the position where the battery cell 10 is to be installed on the worktable 120 when the battery cell 10 has a structure in which the positive electrode tab 13 and the negative electrode tab 14 face each other. Alternatively, the guide jig 210 may comprise the second type guide jig 210b that guides a position where the battery cell 10 is to be placed on the worktable 120 when the battery cell 10 has a structure in which the positive electrode tab 13 and the negative electrode tab 14 are formed at one side of the battery cell 10.

The battery cell 10 may have various shapes depending on differences in its length, width, thickness, the orientation of the tab, the presence or absence of the folding portion 16, the length of the tab, etc. Therefore, a plurality of guide jigs 210 may be provided depending on the type of battery cell 10. Although the guide jig 210 is described as being classified into two types based on the orientation of the tab as set forth herein, it should be understood that the specific configuration of the guide jig 210 may vary. The guide jig 210 may be made of an electrically insulating material or coated with an electrically insulating material.

The first type guide jig 210a may comprise a first plate 211 and a second plate 212. The first type guide jig 210a may be used for a battery cell 10 having a structure in which a positive electrode tab 13 and a negative electrode tab 14 respectively exist on opposite sides of the battery cell 10. The first plate 211 may be disposed orthogonal to a moving direction of the conveyor belt 110. The second plate 212 may be disposed parallel to the moving direction of the conveyor belt 110. The first plate 211 and the second plate 212 may be arranged orthogonal to each other. The second plate 212 may be fixed to the first plate 211. The first plate 211 and the second plate 212 may be coupled to each other so that the second plate 212 can slide in a longitudinal direction of the first plate 211 and be temporarily fixed. The first plate 211 may align the battery cell 10 by making contact with one side surface of the battery cell 10 among two opposite side surfaces where no tab exits. The second plate 212 may align the battery cell 10 by making contact with one side surface of the battery cell 10 among two opposite side surfaces where the tab exits. The second plate 212 may align the battery cell 10 by making contact with the side surface of the battery cell 10 where the negative electrode tab 14 exits. The second plate 212 may be of such a size as not to make contact with the tab of the battery cell 10.

The second type guide jig 210b may comprise a first plate 211 and a second plate 212. The second type guide jig 210b may be used for a battery cell 10 having a structure in which both a positive electrode tab 13 and a negative electrode tab 14 exist in parallel at one side of the battery cell 10. The first plate 211 may be disposed orthogonal to a moving direction of the conveyor belt 110. The second plate 212 may be disposed parallel to the moving direction of the conveyor belt 110. The first plate 211 and the second plate 212 may be arranged orthogonal to each other. The second plate 212 may be fixed to the first plate 211. The first plate 211 and the second plate 212 may be coupled to each other so that the second plate 212 can slide in a longitudinal direction of the first plate 211 and be temporarily fixed. The second plate 212 may align the battery cell 10 by making contact with a side surface of the battery cell 10 opposite to one side surface where the tab exits. The first plate 211 may align the battery cell 10 by making contact with one side surface of the battery cell 10 where no tab exits.

The position sensor 230 of the guide jig 210 may be coupled to the guide jig 210. The position sensor 230 may measure whether the battery cell 10 is in close contact with the guide jig 210. At least one position sensor 230 may be disposed on the first plate 211 to sense whether the battery cell 10 is in close contact with the first plate 211. At least one position sensor 230 may be disposed on the second plate 212 to sense whether the battery cell 10 is in close contact with the second plate 212. The position sensor 230 may be various types of sensors. For example, the position sensor 230 may comprise a fiber sensor, a distance sensor, a light sensor, an ultrasonic sensor, etc. The position sensor 230 may also comprise a vision monitoring system using a camera. The apparatus 1 for disposing of battery cells may temporarily halter the process and issue a visual or auditory alarm to a worker when the battery cell 10 is not in close contact with the guide jig 210. In this case, the worker may reposition the battery cell 10 in a correct location and restart the process.

In FIG. 3, step S100 of placing the battery cell 10 on the worktable 120 of the conveying device 100 using the guiding device 200 may comprise moving the empty worktable 120 to the guiding device 200 (S101) and placing the battery cell 10 onto the empty worktable 120 (S102). To load the battery cell 10, the conveying device 100 may move the worktable 120 by one pitch at a time in a predetermined direction, and may load the battery cell 10 when the empty worktable 120 reaches a position where the guiding device 200 is installed. When the empty worktable 120 moves to the guiding device 200, the worker or robot for the battery cell 10 may convey the battery cell 10 onto the worktable 120 of the conveying device 100. At this time, the worker or robot places the battery cell 10 so as to make close contact with the guide jig 210.

In FIG. 4, step S200 of sensing, by the guiding device 200, the position where the battery cell 10 is placed may sense whether the battery cell 10 exists at a predetermined point using the position sensor 230, and when the battery cell 10 does not exist at the predetermined point, may determine that the battery cell 10 is not placed in a correct position. The predetermined point measured by the position sensor 230 is a point very close to the first plate 211 or the second plate 212. When the battery cell 10 makes close contact with the first plate 211 and the second plate 212, a part of the battery cell 10 is positioned at the predetermined point measured by the position sensor 230. When the battery cell 10 is not placed in the correct position, a sensing value output by the position sensor 230 is different. When it is determined that a different sensing value is output and the battery cell 10 is not placed in the correct position, the process may be halted or an alarm may be issued to the worker.

When the empty worktable 120 is moved to the guiding device 200 by the conveying device 100 and the position sensor 230 determines that the battery cell 10 is placed in the predetermined position by the guiding device 200, the conveying device 100 may move the worktable 120 by one pitch to convey the battery cell 10 to a subsequent step. Moving the worktable 120 using the conveying device 100 by one pitch at a time after performing each step of the process may be achieved using well-known techniques.

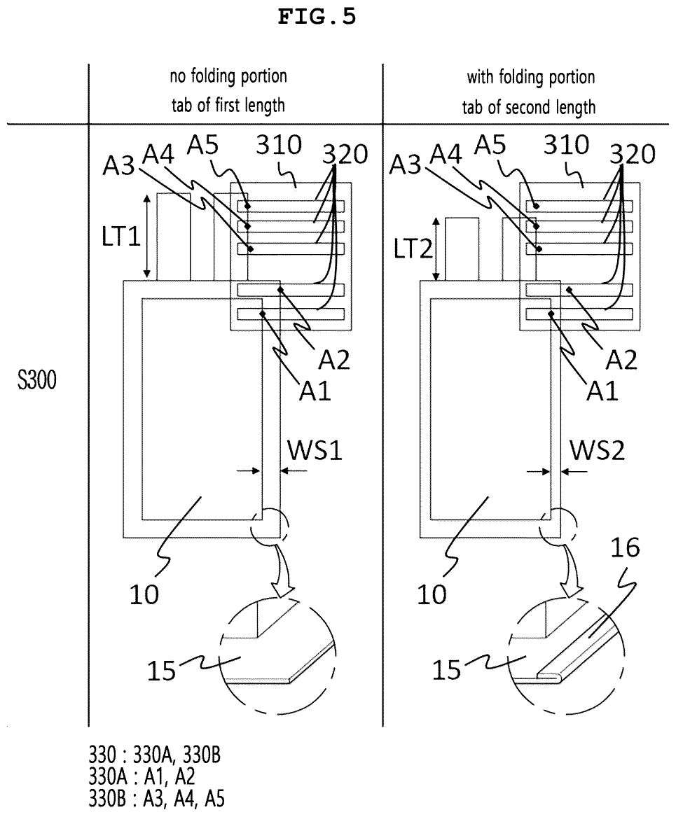

FIG. 5 is a view illustrating a sensing device 300 for sensing a folding portion 16 and a tab of a battery cell 10 according to an embodiment. FIG. 5 comparatively illustrates sensing of a battery cell 10 having no folding portion 16 and an uncut tab and a battery cell 10 having a folding portion 16 and a cut tab. In FIG. 5, other configurations of the sensing device 300 are omitted. FIGS. 1 and 2 are referred together.

In step S300 of sensing the presence of absence of the folding portion 16 and the length of the tab of the battery cell 10, the sensing device 300 may sense the presence of absence of the folding portion 16 and the position of the tab of the battery cell 10 placed on the worktable 120. The sensing device 300 may comprise a board 310 having at least one slit 320 formed therein, and a plurality of sensors 330 fixed at predetermined positions in the slits 320 of the board 310. The board 310 may fix the plurality of sensors 330 to the predetermined positions. The board 310 may be installed at a position spaced apart from the conveying device 100 so as not to interfere with the worktable 120 and the battery cell 10 moved by the conveying device 100. The board 310 may comprise a plurality of slits 320 or a plurality of holes. The slits 320 formed in the board 310 are elongated holes penetrating the board 310. The sensors 330 may be fixed to the slits 320. The slits 320 may be formed to extend in one direction so that the sensors 330 are fixed at desired positions. The slits 320 may be formed in the board 310 to be spaced apart from each other at regular intervals.

The sensors 330 may comprise a first sensor 330A that measures the presence of absence of the folding portion 16 of the battery cell 10, and a second sensor 330B that measures the length of the tab of the battery cell 10. The first sensor 330A and the second sensor 330B may be the same type of sensors. The sensor 330 fixed on a slot of the board 310 at a position where the folding portion 16 of the battery cell 10 may exist may be referred to as the first sensor 330A, and the sensor 330 fixed at a position where the tab of the battery cell 10 may exist may be referred to as the second sensor 330B. For example, in FIG. 5, the first sensor 330A may comprise sensors A1 and A2, and the second sensor 330B may comprise as sensors A3, A4, and A5.

For the battery cell 10 having no folding portion 16, an elongated sealing portion 15 exits. Therefore, both the sensor A1 and the sensor A2 may sense the presence of an object, and the sensing device 300 may determine that there is no folding portion 16 in the battery cell 10. In this case, the sealing portion 15 may have a width WS1 equal to or greater than a predetermined value. For the battery cell 10 having the folding portion 16, a sealing portion 15 is rolled. Therefore, the sensor A1 may sense the presence of an object whereas the sensor A2 may not sense the object, and the sensing device 300 may determine that there is the folding portion 16 in the battery cell 10. In this case, the sealing portion 15 may have a width WS2 equal to or less than a predetermined value.

In the case of the battery cell 10 having a tab with a first length LT1, the sensors A3, A4, and A5 may all sense the presence of an object, and the sensing device 300 may calculate the first length LT1 of the tab of the battery cell 10. For the battery cell 10 having a tab with a second length LT2, the sensors A3 and A4 may sense the presence of an object whereas the sensor A5 may not sense the object, and the sensing device 300 may calculate the second length LT2 of the tab of the battery cell 10. Since the positions of the sensors 330 and the position where the battery cell 10 is placed by the guiding device 200 are prestored, the sensing device 300 may calculate the length of the tab of the battery cell 10 based on an output value of the sensors 330. For example, as illustrated in FIG. 5, the first length LT1 may be longer than the second length LT2.

The battery cell 10 may be provided in various types depending on its length, width, height, etc. Accordingly, a board 310 with sensors 330 arranged at different positions may be used for each type of battery cell 10. The board 310 may be detachably coupled to the sensing device 300. The sensing device 300 may be connected to a plurality of boards 310. In this case, the position of each of the boards 310 may be changed so that measurements are made using a different type of board 310.

When the sensing device 300 measures the presence or absence of the folding portion 16 and the position of the tab of the battery cell 10, the conveying device 100 may move the worktable 120 by one pitch to convey the battery cell 10 to the aligning device 400. Alternatively, the sensing device 300 and the aligning device 400 may be configured as a single device. In this case, when the sensing device 300 finishes sensing, the aligning device 400 may align the battery cell 10.

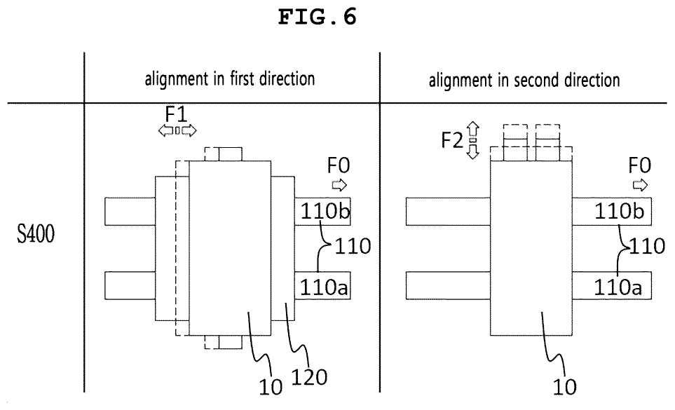

FIG. 6 is a view illustrating a step of aligning a battery cell 10 by an aligning device 400 (S400) according to an embodiment.

In FIG. 6, the aligning device 400 is not specifically illustrated, while the battery cell 10 moved by the aligning device 400 is illustrated. The aligning device 400 may move the battery cell 10 by adsorbing the battery cell 10, gripping the battery cell 10, or pushing the battery cell 10 using a protrusion. The aligning device 400 may be physically implemented in various structures. The aligning device 400 according to the embodiment may perform a function of aligning the battery cell 10 to a position suitable for the damaging device DD to damage the battery cell 10, based on the presence or absence of the folding portion 16 and the length of the tab of the battery cell 10 measured by the sensing device 300.

In step S400 of aligning the battery cell 10, the aligning device 400 may align the battery cell 10 conveyed by the conveying device 100 in the first direction F1 based on the presence or absence of the folding portion 16 of the battery cell 10. When there is the folding portion 16 in the battery cell 10, the width SW2 of the sealing portion 15 is equal to or less than a predetermined value, resulting in a narrow width of the battery cell 10 (see FIG. 5). When there is no folding portion 16 in the battery cell 10, the width SW1 of the sealing portion 15 is equal to or greater than a predetermined value, resulting in a wide width of the battery cell 10 (see FIG. 5). The aligning device 400 may align the battery cell 10 to a position suitable for the damaging device DD to perform incising or cutting by moving the battery cell 10 in a width direction of the battery cell 10. Here, the first direction F1 refers to the width direction of the battery cell 10, and as illustrated in FIG. 6, it may correspond to a direction in which the conveying device 100 conveys the battery cell 10. This is because when the battery cell 10 is placed using the guiding device 200, the width direction of the battery cell 10 is oriented in the same direction as the convey direction F0 of the conveying device 100. Referring to FIG. 6, the battery cell 10 before alignment is indicated by a dotted line, and the battery cell 10 after alignment is indicated by a solid line. As illustrated, it is seen that the aligning device 400 has moved the battery cell 10 in the first direction F1.

In step S400 of aligning the battery cell 10, the aligning device 400 may align the battery cell 10 in the second direction F2 based on the length of the tab of the battery cell 10. When the tab of the battery cell 10 is long, there is a possibility that the cutting device 500 and the tab may make contact with each other upon cutting of the battery cell 10. When the length of the tab of the battery cell 10 is short, the battery cell 10 may not be positioned within the cutting range of the cutting device 500 upon cutting of the battery cell 10. In this case, the aligning device 400 may align the battery cell 10 to a position suitable for the damaging device DD to perform incising or cutting by moving the battery cell 10 in a direction in which the tab of the battery cell 10 is located. Here, the second direction F2 refers to the direction in which the tab of the battery cell 10 is located, and at the same time corresponds to a longitudinal direction of the battery cell 10. As illustrated in FIG. 6, the second direction F2 may be orthogonal to the direction F0 in which the conveying device 100 conveys the battery cell 10. This is because when the battery cell 10 is placed using the guiding device 200, the longitudinal direction of the battery cell 10 is oriented in a direction orthogonal to the convey direction F0 of the conveying device 100. Referring to FIG. 6, the battery cell 10 before alignment is indicated by a dotted line, the battery cell 10 after alignment is indicated by a solid line. As illustrated, it is seen that the aligning device 400 has moved the battery cell 10 in the second direction F2.

When the battery cell 10 is aligned to a predetermined position, step SDD of damaging the part of the pouch film 12 of the battery cell 10 may be performed. Step SDD of damaging the part of the pouch film 12 of the battery cell 10 may comprise either or both of cutting, by the cutting device 500, a region between a cup portion 17 and a tab weld TW of the battery cell 10 conveyed by the conveying device 100 (S500), and incising, by the incising device 600, the pouch film 12 of the cup portion 17 on an upper surface of the battery cell 10 conveyed by the conveying device 100 (S600). The battery cell 10 may be cut using the cutting device 500 and then incised using the incising device 600. Alternatively, the battery cell 10 may be damaged in the reverse order. Step S500 of cutting the region between the cup portion 17 and the tab weld TW of the battery cell 10 will described.

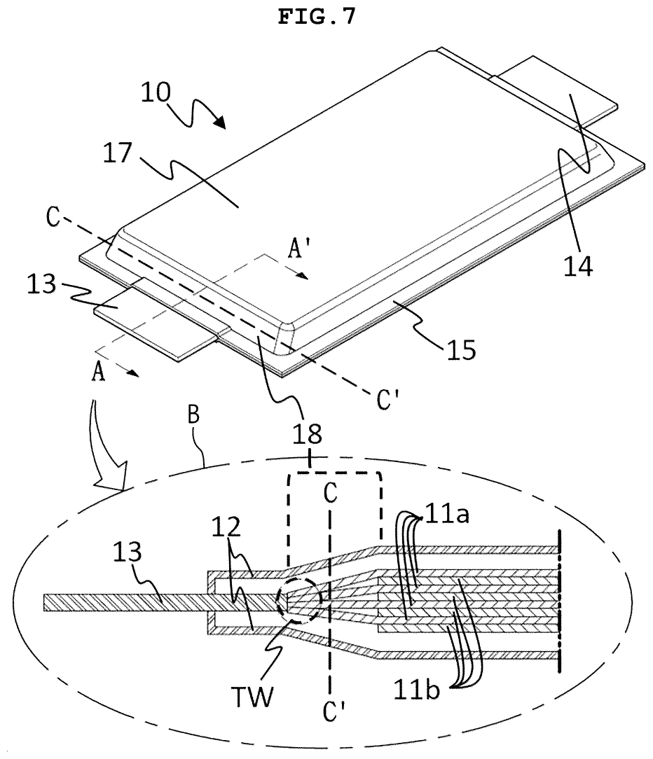

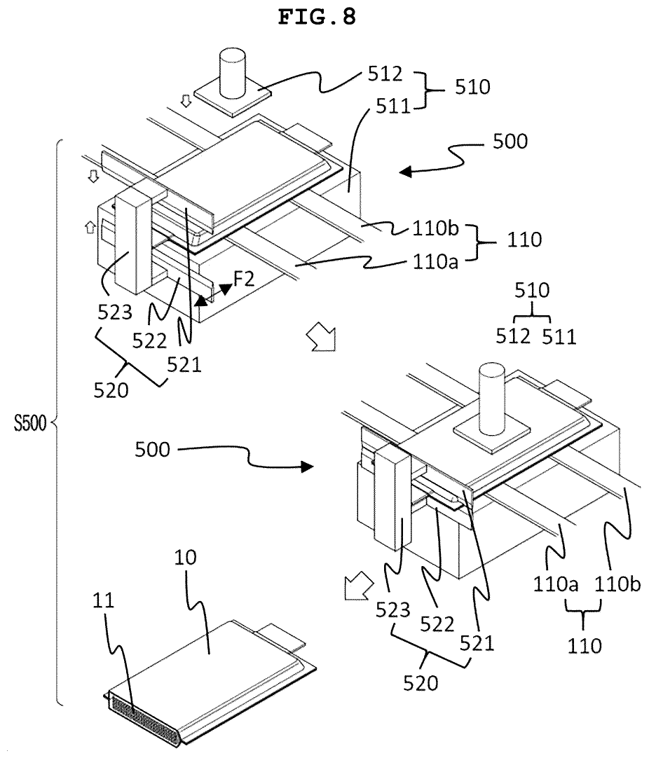

FIG. 7 is a view illustrating a position where a cutting device 500 cuts a battery cell 10 according to an embodiment. FIG. 8 is a view illustrating a cutting device 500 for cutting a battery cell 10 according to an embodiment.

First, the position where the cutting device 500 cuts the battery cell 10 will be described. In order to dispose of the battery cell 10, it is necessary to discharge electrical energy stored in the battery cell 10. To this end, the apparatus 1 for disposing of battery cells according to the embodiment may utilize a method of damaging the pouch film 12 enclosing the outside of the battery cell 10, unloading the damaged battery cell 10, and then placing the cell 10 into the tank 3. At this time, the pouch film 12 needs to be sufficiently damaged to an extent that allows a discharge solution to sufficiently penetrate into the electrode assembly 11 of the battery cell 10.

The position where the battery cell 10 is cut is defined between the cup portion 17 and the tab weld TW. The cup portion 17 is a part formed into a cup shape to accommodate the electrode assembly 11 inside the battery cell 10. The tab weld TW is a point where negative electrodes 11b of the electrode assembly 11 and the negative electrode tab 14 are welded together. Alternatively, the tab weld TW is a point where positive electrodes 11a of the electrode assembly 11 and the positive electrode tab 13 are welded together. The tab weld TW is spaced a predetermined interval apart from the electrode assembly 11. The position where the battery cell 10 is cut may be defined as being between the tab weld TW and the electrode assembly 11. In FIG. 7, the position where the battery cell 10 is cut is indicated by a cutting line C-C′. As illustrated in an enlarged view B taken along line A-A′ in FIG. 7, the cutting line C-C′ may be located between the tab weld TW and the cup portion 17. In other words, the cutting line C-C′ may be located between the tab weld TW and the positive electrodes 11a or the negative electrodes 11b. The region between the tab weld TW and the cup portion 17 may be cut along a straight line as illustrated by the cutting line C-C′ of FIG. 7. In the enlarged view B, separators between the positive electrodes 11a and the negative electrodes 11b are omitted. When the battery cell 10 is cut along the cutting line C-C′, the pouch film 12 may be damaged along the cutting line, thereby exposing the electrode assembly 11 through the damage portion of the pouch film 12. Therefore, when the damaged battery cell 10 is placed into the tank 3, the discharge solution may discharge the battery cell 10 by making sufficient contact with the exposed electrode assembly 11.

The position where the battery cell 10 is cut may also be defined as being on an inclined portion 18 connecting the sealing portion 15 and the cup portion 17 of the battery cell 10 to each other. The inclined portion 18 may generally correspond to the region between the tab weld TW and the cup portion 17.

The cutting position of the battery cell 10 is not limited to the positions described above. For example, the cutting line C-C′ may be implemented in various positions that allow a part of the battery cell 10 to be cut to expose the electrode assembly 11 to the outside.

The cutting device 500 will be described with reference to FIG. 8. A cutting device 500 according to an embodiment is a damaging device DD that damages the pouch film 12. The cutting device 500 may comprise a fixing part 510 that pressurizes and fixes opposite sides of the cup portion 17 of the battery cell 10, and a cutting part 520 that cuts a region between the tab weld TW and the positive electrode tab 13 or the electrode tab of the battery cell 10. The fixing part 510 may pressurize the upper and lower surfaces of the battery cell 10 when cutting the battery cell 10, thereby fixing the battery cell 10 in place so as not to be moved. The fixing part 510 may comprise a first support member 511 positioned below the conveyor belt 110 of the conveying device 100, and a second support member 512 that pressurizes the battery cell 10 while moving toward the first support member 511 from above the battery cell 10. The first support member 511 may be installed close to a lower surface of the conveyor belt 110 so as not to interfere with the movement of the conveyor belt 110. When the upper surface of the battery cell 10 is pressurized by the second support member 512, the conveyor belt 110 and the battery cell 10 may be pressurized and fixed together between the first support member 511 and the second support member 512. The second support member 512 may move up and down by a force generated by a cylinder.

The cutting part 520 may cut a part of the battery cell 10. The cutting part 520 may comprise a lower blade 522 disposed on the lower surface of the battery cell 10, an upper blade 521 disposed on the upper surface of the battery cell 10, and a blade driving portion 523 that cuts the battery cell 10 by moving the upper blade 521 toward the lower blade 522. When the battery cell is conveyed by the conveying device 100, the upper blade 521 and the lower blade 522 are positioned apart from each other. When performing cutting in this state, the upper blade 521 may cut the battery cell 10 while moving toward the lower blade 522. The cutting driving portion 523 may cut the battery cell 10 by moving the upper blade 521 using the force generated by the cylinder.

The cutting driving portion 523 may move the positions of the upper blade 521 and the lower blade 522 closer to or farther away from the conveying device 100. In other words, the cutting driving portion 523 may move the positions of the upper blade 521 and the lower blade 522 in the second direction F2. Since the length of the tab of the battery cell 10 may be long or short, and likewise the length of the battery cell 10 may be long or short, the cutting driving portion 523 may move the upper blade 521 and the lower blade 522 to position the upper blade 521 and the lower blade 522 between the cup portion 17 and the tab weld TW and perform cutting at that position.

The cutting driving portion 523 may perform cutting by moving only the upper blade 521 toward the lower blade 522, or by moving only the lower blade 522 toward the upper blade 521. The cutting driving portion 523 may move the upper blade 521 or the lower blade 522 using a cylinder, a servo motor, or a screw method.

The upper blade 521 and the lower blade 522 may be formed using a hard, non-conductive material. For example, the upper blade 521 and the lower blade 522 may be formed using zirconia. The use of this material prevents a short circuit from occurring even when the upper blade 521 and the lower blade 522 cut the electrode assembly 11 of the battery cell 10.

When one side of the battery cell 10 is cut by the cutting device 500, the electrode assembly 11 may be exposed to the outside as illustrated in FIG. 8.

In step SDD of damaging the part of the pouch film 12, step S600 of incising the incising device 600 by the pouch film 12 will be described.

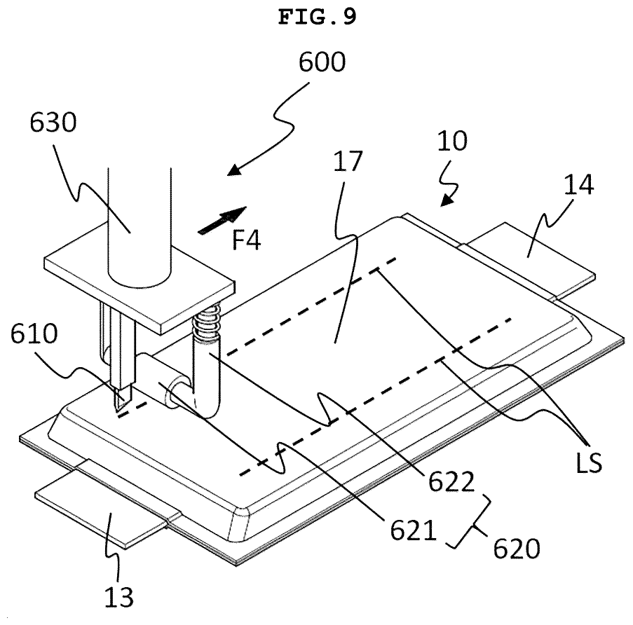

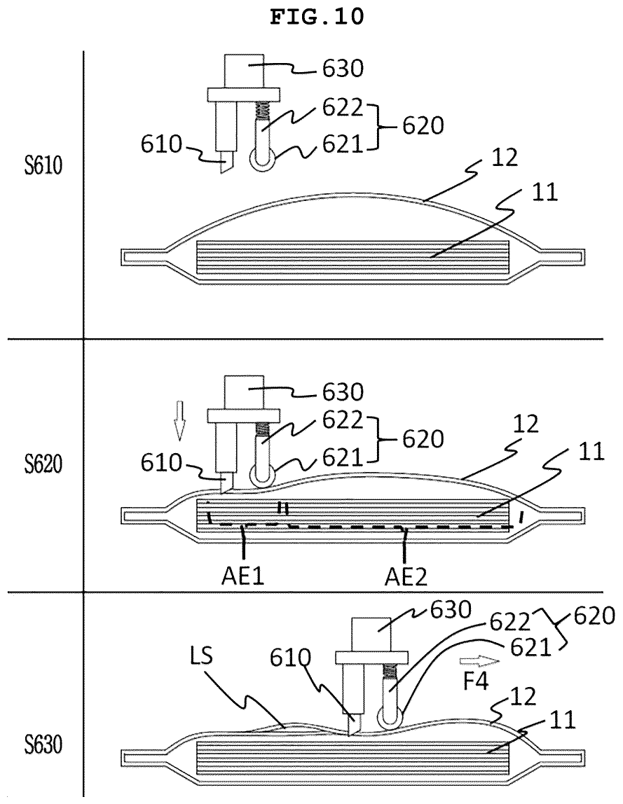

FIG. 9 is a view illustrating a position where a battery cell 10 is incised and an incising device 600 according to an embodiment. FIG. 10 is a view illustrating a step of incising a battery cell 10 (S600) according to an embodiment.

The battery cell 10 has a structure in which the cup portion 17 of the pouch film 12 accommodates the electrode assembly 11, and the incising device 600 may incise a part of the pouch film 12 corresponding to the cup portion 17. The incising is to cut the pouch film 12 along its length using a knife 610. When the incising device 600 incises the pouch film 12 lengthwise, an incision line LS may be formed. The incision line LS is indicated by a dotted line in FIG. 9. The incision line LS may be in the form of an elongated slit resulting from lengthwise cutting the pouch film 12. The electrode assembly 11 may be exposed to the outside through the incision line LS formed in the pouch film 12. The incision line LS may be located on the upper surface of the battery cell 10. In the battery cell 10, the surface facing the worktable 120 or the conveyor belt 110 is referred to as the lower surface, and the surface opposite to the lower surface is referred to as the upper surface. Two parallel incision lines LS may be formed. The incision lines LS may be formed in the longitudinal direction or width direction of the battery cell 10. The orientation or number of the incision lines LS may vary.

The incising device 600 may comprise the knife 610 that incises the pouch film 12 of the battery cell 10, a pressing part 620 located in a front area in a direction F4 in which the knife 610 moves and moving while pressing the pouch film 12, and a moving part 630 that moves the knife 610 and the pressing part 620 in the direction F4 in which incising proceeds. A pouch-type battery cell 10 may expand due to formation of gas therein, which is caused by various reasons such as deterioration or defects. When the knife 610 penetrates deeply into the electrode assembly 11, there is a risk of a short circuit. To prevent this, the knife 610 needs to make contact with the battery cell only to a depth corresponding to the pouch film 12 so as to cut only the pouch film 12. When the pouch film 12 is swollen, it may be difficult to insert the knife 610 at a correct depth into the battery cell 10. Accordingly, the pressing part 620 according to the embodiment may move while pressing the swollen pouch film 12 in a front area in the direction F4 in which the knife 610 moves, thereby allowing the knife 610 to accurately incise the pouch film 12 pressed by the pressing part 620.

The knife 610 may be formed using an electrically insulating material so that a short circuit is prevented even upon contact with the electrode assembly 11. The knife 610 may be formed using zirconia. The knife 610 may be connected to the moving part 630 to incise the pouch film 12 in a direction in which the moving part 630 moves.

The pressing part 620 may be located in the front area in the direction F4 in which the knife 610 moves, and may be connected to the moving part 630. The pressing part 620 may press the pouch film 12 as the moving part 630 moves toward the pouch film 12. The pressing part 620 may comprise a roller 621 that rotates in contact with the pouch film 12 of the battery cell 10, and an elastic portion 622 that presses the roller 621 against the battery cell 10 with a predetermined pressure. The elastic portion 622 presses the roller 621 against the pouch film 12 of the cup portion 17 of the battery cell 10, and the roller 621 presses the pouch film 12 sequentially in a direction in which the moving part 630 moves while rotating. The roller 621 may be connected to the elastic portion 622, and the elastic portion 622 may be connected to the moving part 630. The elastic portion 622 may use a spring or the like to elastically bias the roller 621 into close contact with the battery cell 10 when the moving part 630 applies pressure in the direction of the battery cell 10. The roller 621 may press the pouch film 12 while rotating as the moving part 630 moves in the direction in which incising proceeds.

The moving part 630 may move the knife 610 and the pressing part 620. The moving part 630 may move in the first direction F1, the second direction F2, and a direction orthogonal to both the first direction F1 and the second direction F2. The moving part 630 may be a device that moves according to the movement of a robot arm or frame.

When the battery cell 10 is conveyed to the incising device 600 by the conveying device 100, step S600 of incising the pouch film 12 may be performed. Step S600 of incising the pouch film 12 may comprise: moving, by the moving part 630 of the incising device 600, the knife 610 and the pressing part 620 to a predetermined position of the battery cell 10 (S610); pressurizing, by the moving part 630 of the incising device 600, the knife 610 so that the knife 610 pierces a cup portion 17 of the battery cell 10 to a predetermined depth (S620); and moving, by the moving part 630 of the incising device 600, the pressing part 620 and the knife 610 in a predetermined direction so that the knife 610 incises the pouch film 12 while the pressing part 620 presses the pouch film 12 (S630).

First, the incising device 600 may move the knife 610 and the pressing part 620 to a predetermined position of the battery cell 10 through the moving part 630. The moving part 630 may position the knife 610 to a location corresponding to a starting point of the cup portion 17 of the battery cell 10. Since the length or position of the cup portion 17 of the battery cell 10 may vary depending on the length and width of the cell 10, the presence or absence of the folding portion 16, etc., the moving part 630 may first perform a process of moving the knife 610 to a starting point for incision. At this time, the moving part 630 may move in ether the first direction F1 or the second direction F2.

When the knife 610 moves to a position corresponding to the incision starting point, the moving part 630 may pressurize the knife 610 against a battery module so that the knife 610 pierces the pouch film 12 of the cup portion 17 of the battery cell 10. When the moving part 630 moves to a predetermined position relative to the battery module, the spring of the pressing part 620 may pressingly bias the roller 621 toward the upper surface of the battery cell 10, thereby bringing the swollen pouch film 12 into close contact with the electrode assembly 11. The knife 610 may pierce the pouch film 12 at the incision starting point. The pouch film 12 may be in a swollen state in a front area AE2 in the direction F4 in which the pressing part 620 moves. The pouch film 12 may become flattened in a pressing area AE1 where the pressing part 620 presses the pouch film 12, thereby allowing the knife 610 to accurately incise the pouch film 12 along the incision line LS.

When the knife 610 pierces the battery cell 10 to a predetermined extent, the moving part 630 may move horizontally in the predetermined direction F4 to incise the pouch film 12. As the moving part 630 moves horizontally, the pressing part 620 may press the pouch film 12 while moving in the direction F4 in which incising proceeds, and the knife 610 may incise the pouch film 12 while moving following the pressing part 620.

When the battery cell 10 is damaged, the conveying device 100 may convey the damaged battery cell 10 to the unloading device 700. The unloading device 700 may lift and unload the damaged battery cell 10 from the conveying device 100.

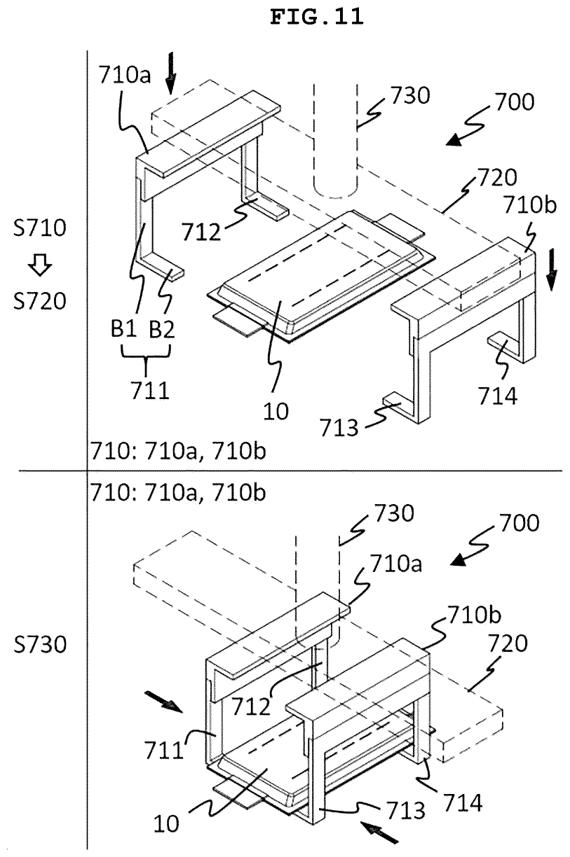

FIG. 11 is a view illustrating an unloading device 700 for unloading a battery cell 10 according to an embodiment.

The unloading device 700 may comprise a plurality of forks 710 that make contact with the lower surface of the battery cell 10, a fork driving part 720 to which the plurality of forks 710 are connected and moving the plurality of forks 710 to narrow or widen the forks 710, and a fork moving part 730 connected to the fork driving part 720 and moving the plurality of forks 710.

The plurality of forks 710 may comprise a first fork 710a and a second fork 710b. The first fork 710a may comprise a plurality of prongs 711 and 712. The second fork 710b may comprise a plurality of prongs 713 and 714. Although FIG. 11 illustrates that each of the first fork 710a and the second fork 710b has two prongs, the present disclosure not limited thereto. For example, each of the first fork 710a and the second fork 710b may have at least three prongs. The plurality of forks 710 may further comprise a third fork or a fourth fork. The first fork 710a and the second fork 710b may be widened to be farther away from each other, or narrowed to be closer to each other. The plurality of forks 710 may move individually and independently of each other. An end of each of the forks 710 may make contact with the lower surface of the battery cell 10. The prong 711 may comprise a first member B1 that is connected to the fork driving part 720 located above the battery cell 10 and extends toward the battery cell 10, and a second member B2 that is bent and extends from the first member B1 toward another facing fork 710. The first member B1 and the second member B2 may have an overall “ [symbol] ” shape. A first end of the first member B1 may be connected to the fork driving part 720, a second end of the first member B1 and a first end of the second member B2 may be connected to each other, and a second end of the second member B2 may make contact with the lower surface of the battery cell 10.

The fork driving part 720 may widen the first fork 710a and the second fork 710b to be farther away from each other or narrow them to be closer to each other. The fork driving part 720 may use a servo motor, gear, or other various drive methods. The fork driving part 720 may be connected to the fork moving part 730. The fork driving part 720 may be moved by the fork moving part 730.

The fork moving part 730 may move the fork driving part 720 to which the plurality of forks 710 are connected. When fork driving part 720 narrows the forks 710 so that the forks 710 make contact with the lower surface of the battery cell 10, the fork moving part 730 may lift the fork driving part 720 to unload the battery cell 10 from the conveying device 100 and move the battery cell 10 to a predetermined position outside the conveying device 100.

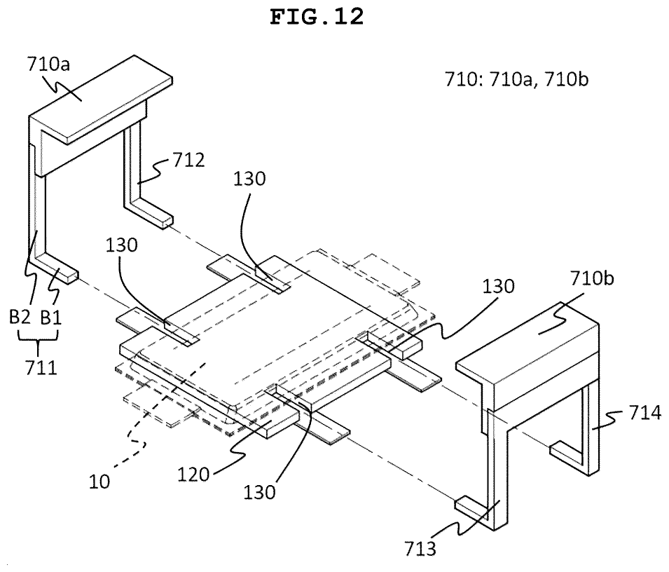

FIG. 12 is a view illustrating a worktable 120 with a fork groove 130 formed therein according to an embodiment.

In order for a fork 710 to make contact with the lower surface of the battery cell 10 while the battery cell 10 is placed on the worktable 120 or the conveyor belt 110, a space for insertion of the fork 710 is required.

The worktable 120 may have a structure in which a plurality of fork grooves 130 are formed at positions where the plurality of forks 710 make contact with the lower surface of the battery cell 10 so that when the fork driving part 720 narrows the forks 710, the forks 710 are inserted into the fork grooves 130 of the worktable 120. The fork grooves 130 formed in the worktable 120 may be formed in number corresponding to the number of the forks 710 of the unloading device 700. The fork grooves 130 may have a larger size than the prongs 711, 712, 713, and 714 of the forks 710 to allow the prongs 711, 712, 713, and 714 of the forks 710 to be inserted therein. The fork grooves 130 may be in a form in which a part of an upper surface and a part of a side surface of the worktable 120 are removed, while a lower surface thereof remains. Alternatively, the fork grooves 130 may be in a form in which the upper and lower surfaces of the worktable 120 are penetrated, while a part of the side surface thereof is removed. The fork grooves 130 may be formed to conform to the shape of the forks 710. The worktable 120 may have a plurality of fork grooves 130 formed in the direction in which the first fork 710a is inserted, and a plurality of fork grooves 130 formed in a direction in which the second fork 710b is inserted. When the prongs 711 and 712 of the first fork 710a and the prongs 713 and 714 of the second fork 710b face each other, the fork grooves 130 may also be formed to face each other.

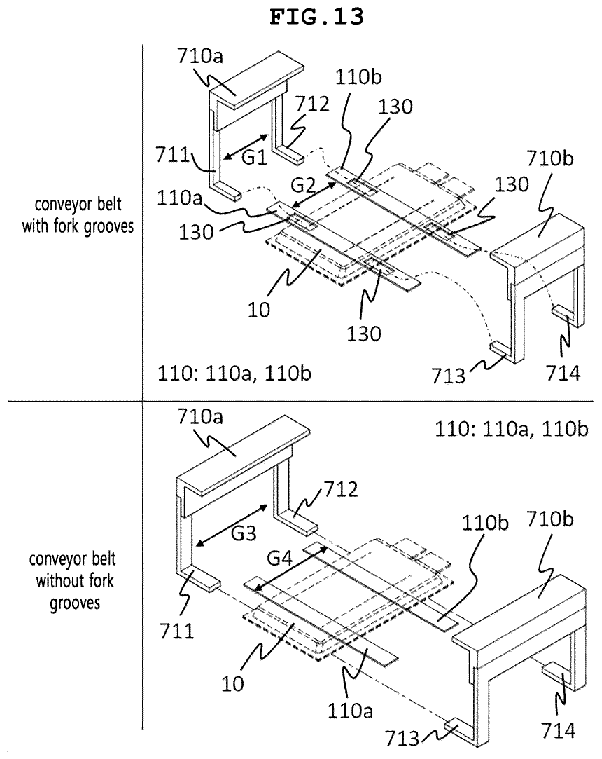

FIG. 13 is a view illustrating an unloading device 700 with no worktable 120 according to an embodiment.

When the battery cell 10 is placed on the conveyor belt 110 of the conveying device 100 with no worktable 120, a fork groove 130 may be formed in the conveyor belt 110. The fork groove 130 may be in a form in which a part of the conveyor belt 110 is removed. The fork groove 13 may have a larger length than the second member B2 (see FIG. 11) of the fork 710. This configuration may be employed in a structure in which the prongs of the fork 710 need to make contact with the lower surface of the battery cell 10 by passing through the conveyor belt 110. In other words, this configuration may be employed in a structure in which a gap G1 between the prongs 711 and 712 of the fork 710 corresponds to a width G2 of the conveyor belt 110.

When the battery cell 10 is placed on the conveyor belt 110 of the conveying device 100 with no worktable 120 and the length of the battery cell 10 exceeds the distance between facing forks 710, the unloading device 700 may have a structure in which a gap G3 between the prongs 711 and 712 of the fork 710 exceeds a width G4 of the conveyor belt 110. When the gap G3 between the prongs 711 and 712 exceeds the width G4 of the conveyor belt 110, the fork 710 may make contact with the lower surface of the battery cell 10 without requiring the formation of the fork groove 130 in the conveyor belt 110. In this structure, the length of the battery cell 10 needs to exceed the width of the conveyor belt 110.

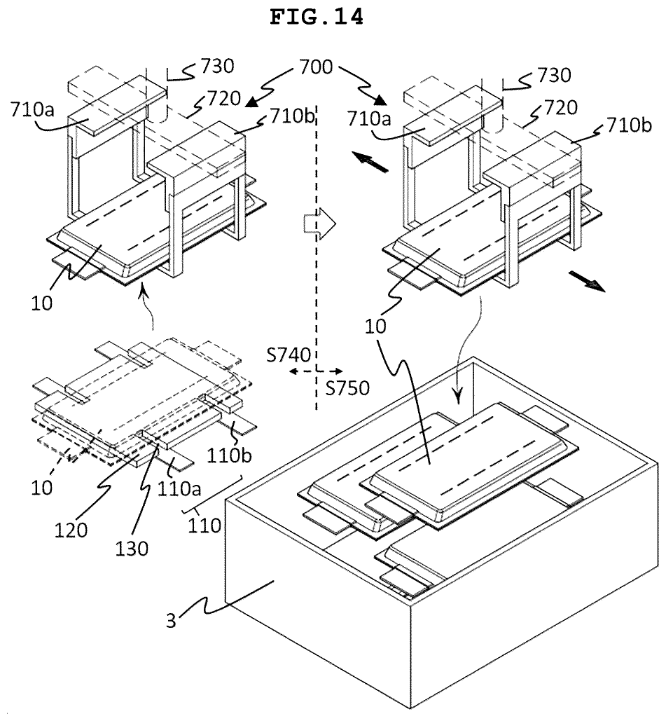

FIG. 14 is a view illustrating a step of unloading a battery cell 10 by an unloading device 700 (S700) according to an embodiment.

Step S700 of unloading the battery cell 10 may comprise: widening, by the fork driving part 720 of the unloading device 700, the plurality of forks 710 so that the distance between the forks 710 exceeds the size of the battery cell 10 (S710 of FIG. 11); moving, by the fork moving part 730 of the unloading device 700, the forks 710 to below the lower surface of the battery cell 10 (S720); narrowing, by the fork driving part 720 of the unloading device 700, the forks 710 so that the distance between the forks 710 is less than the size of the battery cell 10 (S730); and lifting, by the fork moving part 730 of the unloading device 700, the forks 710 so that the forks 710 make contact with the lower surface of the battery cell 10, and unloading the battery cell 10 from the conveying device 100 (S740). Step S700 may further comprise moving the lifted battery cell 10 to a predetermined position and releasing the battery cell 10 by widening the forks 710 (S750).

When the fork driving part 720 of the unloading device 700 widens the forks 710 and the fork moving part 730 positions the prongs of the forks 710 laterally of the lower surface of the battery cell 10, the state illustrated in S710 and S720 of FIG. 11 is achieved. Then, when the fork driving part 720 narrows the forks 710, the state illustrated in S730 of FIG. 11 is achieved. When the fork moving part 730 lifts the forks 710, the battery cell 10 may be lifted from the work table 120 as in the state illustrated in S740 of FIG. 14. The fork moving part 730 may move to a predetermined position outside the conveying device 100 while holding the battery cell 10 lifted. When the fork driving part 720 widens the forks 710, the battery cell 10 may be placed in a predetermined position as in the state illustrated in S750 of FIG. 14. Since the unloading device 700 makes contact with only the lower surface of the damaged battery cell 10 to lift, move, and unload the battery cell 10, a short circuit is prevented from occurring during the unloading process. The position where the unloading device 700 unloads the damaged battery cell 10 may be the magazine 2 for storing the battery cell 10, the buffer for temporarily storing the battery cell 10, or the tank 3 containing the discharge solution for discharging the battery cell 10.

The apparatus 1 for disposing of battery cells having the above-described structure uses a mechanical device to damage the battery cell 10, thereby preventing accidents to workers and ensure safety. Furthermore, the battery cell 10 is damaged at a predetermined position and to a predetermined extent, thereby being safely damaged without being short-circuited. The apparatus 1 for disposing of battery cells employs only either of the cutting device 500 or the incising device 600 as the damaging device DD, thereby simplifying the process steps. The unloading device 700 makes contact with the lower surface of the battery cell 10 so that the forks 710 do not make contact with the damaged portion of the battery cell 10 in both cases where the side surface of the battery cell 10 is cut and the upper surface thereof is incised. Therefore, it is possible to prevent accidents caused by short circuits.

Hereinabove, the present disclosure has been described in detail with reference to specific embodiments. The embodiments are intended to illustrate the present disclosure in detail, and the present disclosure is not limited thereto. It will be apparent to those skilled in the art that modifications thereto or improvements thereof are possible within the technical spirit of the present disclosure.

All simple modifications and alterations of the present disclosure fall within the scope of the present disclosure, and the specific protection scope of the present disclosure will be clearly defined by the appended claims.

What is claimed is:

1. An apparatus for disposing of battery cells, the apparatus comprising:
a conveying device configured to convey a worktable with a battery cell placed thereon in one direction;
a guiding device configured to guide a position where the battery cell is to be placed on the worktable and sense whether the battery cell is placed on the worktable;
a sensing device configured to sense a presence or absence of a folding portion and a length of a tab of the battery cell;
an aligning device configured to align the battery cell in a first direction based on the presence or absence of the folding portion and align the battery cell in a second direction based on the length of the tab;
a damaging device configured to damage a part of a pouch film so that an electrode assembly inside the battery cell is exposed; and
an unloading device configured to make contact with a lower surface of the damaged battery cell and lift the battery cell from the worktable.

2. The apparatus of claim 1, wherein the damaging device comprises either or both of:
a cutting device configured to cut a region between a cup portion and a tab weld of the battery cell to open a side surface of the battery cell; and
an incising device configured to incise the pouch film of the cup portion on an upper surface of the battery cell.

3. The apparatus of claim 1, wherein the guiding device comprises:
a guide jig configured to guide the battery cell to be placed in a predetermined position on the worktable; and
a position sensor configured to measure whether the battery cell is placed on the worktable,
wherein the guide jig comprises:
a first type guide jig configured to guide the position where the battery cell is to be placed on the worktable when the battery cell has a structure in which a positive electrode tab and a negative electrode tab face each other, and
a second type guide jig configured to guide the position where the battery cell is to be placed on the worktable when the battery cell has a structure in which the positive electrode tab and the negative electrode tab are formed at one side of the battery cell.

4. The apparatus of claim 1, wherein the sensing device comprises:
a board having at least one slit formed therein; and
a plurality of sensors fixed at predetermined positions in the slits of the board,
wherein the sensors comprises:
a first sensor configured to measure the presence of absence of the folding portion of the battery cell; and
a second sensor configured to measure the length of the tab of the battery cell.

5. The apparatus of claim 2, wherein the cutting device comprises:
a fixing part configured to pressurize and fix opposite sides of the cup portion of the battery cell; and
a cutting part configured to cut a region between the tab weld and a positive electrode tab or an electrode tab of the battery cell,
wherein the cutting part comprises:
a lower blade disposed on the lower surface of the battery cell;
an upper blade disposed on the upper surface of the battery cell; and
a blade driving portion configured to cut the battery cell by moving the upper blade toward the lower blade.

6. The apparatus of claim 2, wherein the incising device comprises:
a knife configured to incise the pouch film of the battery cell;
a pressing part located in a front area in a direction in which the knife moves and configured to move while pressing the pouch film; and
a moving part configured to move the knife and the pressing part in a direction in which incising proceeds.

7. The apparatus of claim 6, wherein the pressing part comprises:
a roller configured to rotate in contact with the pouch film of the battery cell; and
an elastic portion configured to press the roller against the battery cell with a predetermined pressure.

8. The apparatus of claim 1, wherein the unloading device comprises:
a plurality of forks configured to make contact with the lower surface of the battery cell;
a fork driving part to which the plurality of forks are connected and configured to move the plurality of forks to narrow or widen the forks; and
a fork moving part connected to the fork driving part and configured to move the plurality of forks.

9. The apparatus of claim 1, wherein the worktable has a plurality of fork grooves formed at positions where the plurality of forks make contact with the lower surface of the battery cell so that when the fork driving part narrows the forks, the forks are inserted into the fork grooves of the worktable.

10. A method of disposing of battery cells, the method comprising:
placing a battery cell onto a worktable of a conveying device using a guiding device;
sensing, by the guiding device, a position where the battery cell is placed;
sensing, by a sensing device, a presence or absence of a folding portion and a length of a tab of the battery cell conveyed by the conveying device;
aligning, by an aligning device, the battery cell conveyed by the conveying device in a first direction based on the presence or absence of the folding portion and aligning the battery cell in a second direction based on the length of the tab;
damaging a part of a pouch film of the battery cell conveyed by the conveying device so that an electrode assembly inside the battery cell is exposed; and
making contact with a lower surface of the damaged battery cell conveyed by the conveying device and lifting and unloading the battery cell from the conveying device.

11. The method of claim 10, wherein the damaging of the part of the pouch film comprises either or both of:
cutting, by a cutting device, a region between a cup portion and a tab weld of the battery cell conveyed by the conveying device; and
incising, by an incising device, the pouch film of the cup portion on an upper surface of the battery cell conveyed by the conveying device.

12. The method of claim 11, wherein the incising of the pouch film comprises:
moving, by a moving part of the incising device, a knife and a pressing part to a predetermined position of the battery cell;
pressurizing, by the moving part of the incising device, the knife so that the knife pierces a cup portion of the battery cell to a predetermined depth; and
moving, by the moving part of the incising device, the pressing part and the knife in a predetermined direction so that the knife incises the pouch film while the pressing part presses the pouch film.

13. The method of claim 12, wherein the pressing part comprises:
a roller rotating in contact with the pouch film of the battery cell; and
an elastic portion pressing the roller against the battery cell with a predetermined pressure,
wherein the elastic portion presses the roller against the pouch film of the cup portion of the battery cell, and the roller presses the pouch film sequentially in a direction in which the moving part moves while rotating.

14. The method of claim 10, wherein the unloading of the battery cell comprises:
widening, by a fork driving part of the unloading device, a plurality of forks so that a distance between the forks exceeds a size of the battery cell;
moving, by a fork moving part of the unloading device, the forks to below the lower surface of the battery cell;
narrowing, by the fork driving part of the unloading device, the forks so that the distance between the forks is less than the size of the battery cell; and
lifting, by the fork moving part of the unloading device, the forks so that the forks make contact with the lower surface of the battery cell, and unloading the battery cell from the conveying device,
wherein the worktable has a plurality of fork grooves formed at positions where the plurality of forks make contact with the lower surface of the battery cell so that when the fork driving part narrows the forks, the forks are inserted into the fork grooves of the worktable.
